(19) United States
(12) Patent Application Publication
(10) Pub. No.: US 2011/0139810 A1
(43) Pub. Date: Jun. 16, 2011

(54) SCENT FLUID DISPENSING SYSTEM AND METHODS

(75) Inventor: Scott D. Lee, Lapeer, MI (US)

(73) Assignee: Primos, Inc., Flora, MS (US)

(21) Appl. No.: 12/638,825

(22) Filed: Dec. 15, 2009

(51) Int. Cl. B65D 35/28; B67D 7/60; B65D 83/00

(52) U.S. Cl. 222/1; 222/386.5; 222/95; 222/105; 222/94; 222/402.14

(57) ABSTRACT

An apparatus for continuously dispensing a scent fluid includes a canister, a bag positioned in the canister, and a dispensing mechanism. The canister contains a volume of pressurized fluid such as a pressurized gas. The bag contains a volume of the scent fluid. The bag physically separates the pressurized fluid from the volume of scent fluid. The dispensing mechanism is in fluid communication with the volume of scent fluid. The dispensing mechanism is operable to dispense the scent fluid from the canister. The dispensing mechanism may be operable to continuously dispense the volume of scent fluid.

### TECHNICAL FIELD

The present disclosure relates generally to systems and methods for dispensing fluids, and more specifically relates to systems and methods for dispensing scent liquids in the form of attractant scents and scent masking formulas to be used in hunting.

### BACKGROUND

Animals are often allured to various scents, and in particular, those scents produced by foods and other animals. Hunting some types of animals (i.e., big game animals such as deer, elk, moose, bear, and the like) may involve attracting animals to a hunting area by generating or dispensing various scents. Some hunting techniques involve masking the hunter's own body scent or the scent of activities (i.e., cooking) or equipment (i.e., vehicles, gear, weapons) used by the hunter during the course of hunting the animal. Such masking may involve the application of scent control or scent suppression liquids. Often such scent masking fluids are scent-free.

Various methods and devices have been used to dispense scented materials for attracting animals and/or masking scents. For purposes of simplicity, “scent fluid” or “scent liquid” shall mean either an attractant scent or a scent masking fluid or liquid. An example dispensing device includes a manual pump that sprays a scent fluid onto a target. The target may be the hunter's clothing, equipment, camp site, or other object. Pump dispensers typically dispense the scented fluid as a combination of vapors and droplets of the scent fluid. Further, pump dispensers often generate a spray pattern with an uneven distribution that requires overlapping of the spray in order to ensure full coverage of the object being sprayed. Pump dispensers often provide inadequate coverage of the object being sprayed, or over-spraying of the object (i.e., excess application of the scent fluid). Furthermore, many types of pump dispensers are inoperable if not oriented upright. This makes it difficult in some circumstances for a hunter to spray objects that are vertically higher than the dispenser (e.g., on a ceiling of a hunting blind) or the hunter's own clothing. Consequently, pump dispensers are often inefficient and ineffective for application of the scent fluid.

Another type of scent dispenser includes a container that holds a mixture of a scent fluid and a propellant. In order to effectively dispense the scent liquid, a comparatively large volume of propellant is necessary to provide sufficient pressure for dispensing the scent fluid. The propellant mixes with the scent fluid prior to dispensing, thus diluting the scent fluid that is dispensed. The propellant itself may be a relatively volatile substance, such as, for example, natural gas, butane, propane, or isobutene, which may be flammable and may render the dispensing device hazardous. Further, the propellant is typically released into the atmosphere after dispensing, which may contribute to environmental problems.

Opportunities exist for improvements in the area of scent fluid dispensing systems.

### SUMMARY

One aspect of the present disclosure relates to an apparatus for continuously dispensing a scent fluid. The apparatus may include a canister, a bag positioned in the canister, and a dispensing mechanism. The canister may contain a volume of pressurized fluid such as a pressurized gas. The bag may contain a volume of the scent fluid. The bag physically separates the pressurized fluid from the volume of scent fluid. The dispensing mechanism is in fluid communication with the volume of scent fluid. The dispensing mechanism is operable to dispense the scent fluid from the canister. The dispensing mechanism may be operable to continuously dispense the volume of scent fluid.

The pressurized fluid may exert a compressive force on an exterior surface of the bag to increase a pressure condition in the volume of scent fluid. The dispensing mechanism may be operable to dispense the volume of scent fluid at a constant rate. The volume of pressurized fluid may maintain the volume of scent fluid at a substantially constant pressure condition in the bag. The bag may include at least one flexible sidewall. The dispensing mechanism may include an “on” state wherein the volume of scent fluid is dispensed, and an “off” state wherein the volume of scent fluid is not dispensed. The apparatus may also include a device that retains the dispensing mechanism in the “on” state. The scent fluid may comprise a liquid composition that attracts a particular type of animal. The scent fluid alternatively may comprise a liquid composition that masks human and other odors or scents.

Another aspect of the present disclosure relates to a method of dispensing a scent fluid for use in hunting. The method may include providing a scent dispensing device that includes a first container of scent fluid positioned in a second container of pressurized fluid, and a dispensing mechanism in fluid communication with the scent fluid. The method may also include exerting pressure on an outer surface of the first container with the pressurized fluid to increase a pressure condition of the scent fluid, and activating the dispensing mechanism to dispense a volume of the scent fluid.

Dispensing the volume of scent fluid may include dispensing the scent fluid at a substantially constant rate. Dispensing the volume of scent fluid may include dispensing the scent fluid continuously. Activating the dispensing mechanism may include locking the dispensing mechanism in an “on” state to provide a continuous flow of the scent fluid. Dispensing the volume of the scent fluid may include dispensing the scent fluid from both the first and second containers.

Another aspect of the present disclosure relates to a scent fluid delivery system that includes a housing, a scent fluid container, a volume of pressurized fluid, and a dispensing mechanism. The housing defines a housing interior. The scent fluid container is positioned in the housing interior and has at least one flexible wall. The scent fluid container retains a volume of scent fluid which comprises a chemical composition. The volume of pressurized fluid is retained in the housing interior and configured to act upon an outer surface of the at least one flexible wall of the scent fluid container to increase a pressure condition of the scent fluid within the scent fluid container. The dispensing mechanism is in fluid communication with the volume of scent fluid.

The dispensing mechanism may be configured to dispense the volume of scented fluid at a constant rate. The scent fluid container may be configured as a bag structure. The volume of pressurized fluid may be physically separated from the volume of scent fluid held by the scent fluid container. A volume of pressurized fluid may maintain the volume of scent fluid in a substantially constant pressure condition. The housing may have a generally cylindrical shape with a rigid construction and the dispensing mechanism may be positioned at one end of the housing.

Conditional advantages and novel features will be set forth in the description which follows and will be understood by those skilled in the art through reading these materials and practicing the examples disclosed herein. Some advantages of the examples disclosed herein can be appreciated with reference to the attached claims.

### BRIEF DESCRIPTION OF THE DRAWINGS

The accompanying drawings illustrate various embodiments of the present disclosure and are a part of the specification. The illustrated embodiments are merely examples and do not limit the scope of the present disclosure.

FIG. 1 is a perspective view of an example scent fluid dispensing system in accordance with the present disclosure.

FIG. 2 is a cross-sectional side view of the scent fluid dispensing system of FIG. 1.

FIG. 3 is a cross-sectional side view of the scent fluid dispensing system of FIG. 1 with the valve in an open position.

FIG. 4 is a cross-sectional perspective view of another example scent fluid dispensing system in accordance with the present disclosure.

FIG. 5 is a perspective view of the inner container and dispensing mechanism of the scent fluid dispensing system of FIG. 4.

FIG. 6 is cross-sectional perspective view of another example scent fluid dispensing system in accordance with the present disclosure.

FIG. 7 is a perspective view of the inner containers and dispensing mechanism of the scent fluid dispensing system of FIG. 6.

FIG. 8 is a cross-sectional perspective view of another example scent fluid dispensing system in accordance with the present disclosure.

FIG. 9 is a cross-sectional perspective view of an example prior art scent fluid dispensing system.

Throughout the drawings, identical reference numbers designate similar, but not necessarily identical elements.

### DETAILED DESCRIPTION

As noted in the background section above, there are shortcomings with some known dispensing devices for scent liquids such as pump and propellant type devices. The present disclosure is directed primarily to scent fluid dispensing systems and methods that implement “bag on valve” or similar dispensing technology to dispense a scent fluid. The bag on valve dispensing technology provides physical separation between the scent fluid and a pressurizing fluid prior to, during, and after dispensing of the scent fluid. The pressurized fluid is retained within the dispensing device and not released into the environment. The dispensing device is operable at any orientation (i.e., vertically or horizontally). The dispensing device may be operable to dispense scent fluid until substantially all the scent fluid has been dispensed from the device. The dispensing device may include features that permit continuous dispending of the scent fluid. The scent fluid may be dispensed in an aerosol state. The scent fluid may be dispensed with a substantially constant spray pattern. The scent fluid may be dispensed at a substantially constant rate. A dispensing mechanism of the dispensing device may be operable in a constant or locked “on” state. In some instances, the various components of the dispensing device may be recyclable.

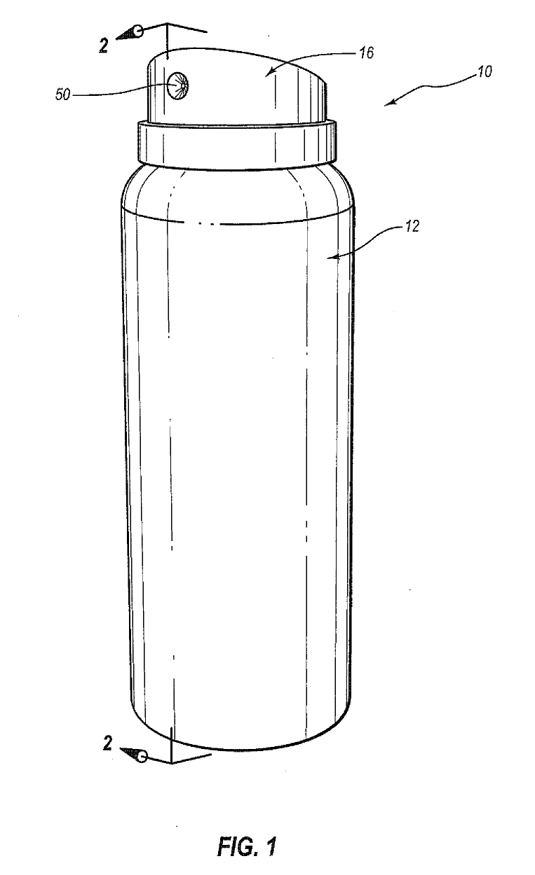

Referring first to FIGS. 1-3, an example scent fluid dispensing system 10 is shown and described. “Scent fluid” or “scent liquid” shall mean any type of attractant scent for attracting animals, including big game animals, as well as scent or odor masking fluids or liquids to be used in connection with hunting. The scent fluid dispensing system 10 includes an outer container 12, an inner container 14, and a dispensing mechanism 16. The outer and inner containers 12, 14 may be referred to as canisters or housings. The inner container 14 may be positioned entirely within the outer container 12. The dispensing mechanism 16 is coupled in fluid communication within an interior of the inner container 14 so as to dispense a volume of fluid (e.g., a scent liquid) that is retained within the inner container 14. The outer container 12 retains a volume of pressurized fluid (e.g., a pressurized gas) that exerts a compressive force upon an outer surface of the inner container 14 to increase a pressure condition of the scent fluid that is retained within the inner container 14. Actuation of the dispensing mechanism 16 causes the volume of scent fluid to be dispensed from the inner container 14 to a location outside of the scent dispensing system 10. The inner container 14 provides a physical separation between the pressurized fluid retained within the outer container 12 and the volume of scent fluid retained within the inner container 14. This type of dispenser may sometimes be referred to as a “bag on valve” dispenser. Bag on valve dispensing devices may provide at least some advantages as compared to other types of scent dispensing devices such as the propellant driven and pump dispensers described above.

The outer container 12 includes a top end 20, a bottom end 22, a top opening 24 having a lip 26 extending from an edge thereof, and an interior volume 28. The outer container 12 may be a rigid structure with a fixed internal volume. The inner container 14 includes a first end 30, a second end 32, a sidewall 34 extending between the first and second ends 30, 32. The inner container 14 defines an interior volume 36. A volume of scent fluid 60 is retained in the interior volume 36.

A space defined between the inner container 14 and the outer container 12 may be filled with a volume of pressurized fluid 62. The pressurized fluid 62 exerts a compressive force P on the sidewall 34 and other surfaces of the inner container 14 to increase a pressure condition within the interior volume 36 of the inner container 14. The inner container 14 may be sealed closed except for an outlet (regulated between “on” and “off” positions) defined by the dispensing mechanism 16. The scent fluid 60 and portions of the dispensing mechanism 16 are positioned within the inner container 14. Thus, as portions of the volume of scent fluid 60 are dispensed through the dispensing mechanism 16, the size and/or shape of the inner container 14 tends to change. At least portions of the inner container 14 (i.e., portions of the sidewall 34) may comprise flexible or resilient material that will permit at least some change of size and/or shape of the inner container 14 as the volume of scent fluid 60 is dispensed through the dispensing mechanism 16.

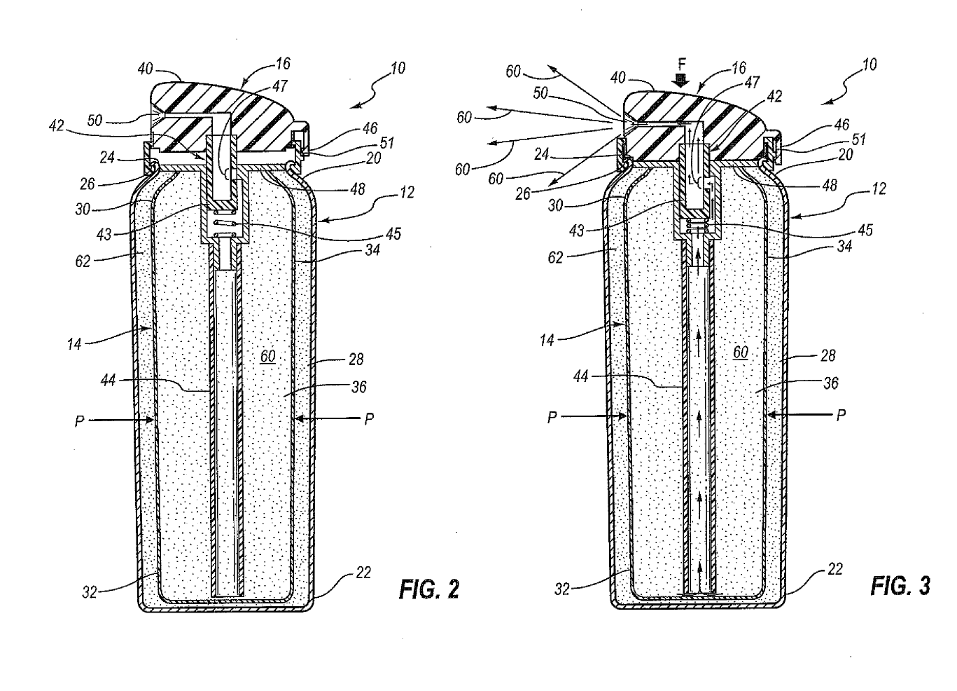

As shown in FIGS. 2 and 3, the dispensing mechanism 16 includes an actuator 40, a valve assembly 42, a dip tube 44, a cap 48, and an outlet 50. The actuator 40 may be exposed for contact by an operator to dispense the volume of scent fluid 60. The actuator 40 may be constructed as a push button device. In operation, a user contacts and pushes on actuator 40 to cause abutment end 43 to overcome the bias force of spring 45 and align opening 47 with the pressurized interior containing the scent fluid. The result is a stream 49 of scent fluid that is allowed to escape from the container. When the user releases pressure on the actuator 40, the valve assembly 42 returns to a closed or off state to prevent further dispensing of the volume of scent fluid 60.

The dip tube 44 extends from the valve assembly 42 into the interior volume 36 of the inner container 14. In some arrangements, a dip tube 44 or similar structure may not be required. In at least some examples, the dip tube 44 may assist in removing a maximum amount of the volume of scent fluid 60 from the inner container 14.

The cap 48 may be constructed for attachment to the outer container 12 for mounting of the dispensing mechanism 16. In some arrangements, the cap 48 is also connected to the inner container 14. In still other arrangements, additional mounting structures may be used to connect the dispensing mechanism 16 to one or both of the outer container 12 and inner container 14. Other structures may be used to connect the cap 48 to the lip 26 of the outer container 12.

The dispensing mechanism 16 may include an on/off locking member 46. FIG. 2 illustrates an example locking member 46 that includes a latch type structure in the form of a resilient tab structure 51 that retains the actuator 40 in a compressed or “on” state that permits a continuous stream 49 of the scent fluid 60 to be emitted from the scent dispensing system 10. The tab 51 of locking member 46 may be releasable to permit the actuator 40 to return to an uncompressed position to shut off the valve system 42 and terminate the flow of scent fluid 60 from the container.

Many types of dispensing mechanisms may be used to access and allow the flow of dispense scent fluid 60 from the inner container 14. Some dispensing devices may include powered valve devices, such as valve devices that may be opened at incremental amounts to more precisely control the rate and/or volume of flow of the scent fluid. Some types of dispensing mechanisms may include various nozzle features that provide control of a spray pattern, droplet size and other characteristics of the scent fluid being dispensed.

The scent fluid 60 may comprise any of a variety of different scent fluids that promote attracting animals or masking scents. An example scent masking or scent elimination composition is disclosed is U.S. Published Application No. 2006/0269509, which is hereby incorporated in its entirety by this reference. Some example attracting scent fluids may include, without limitation, doe deer in estrus, cow elk in estrus, dominant buck, young buck for hunting deer, beaver caster, sow in heat for bear hunting, and sow in heat for hog hunting, fox urine and fawn urine for predator hunting, as well as other attractant scents for big game animals such as hickory smoked bacon, fruit punch, peanut butter, and sweet corn. Typically, the scent fluids are in the form of liquid, but may come in other forms such as gels, foams and vapors.

The pressurized fluid 62 retained in the outer container 12 may be a gas such as air, nitrogen, or other stable, non-flammable gas. In some examples, other types of gases such as natural gas, butane, chlorinated hydrocarbons, or fluorinated hydrocarbons, or some blend thereof may be used as the pressurized fluid. In some examples, the pressurized fluid is in a different state besides gas, such as, for example, a liquid or mixture of liquid and gas.

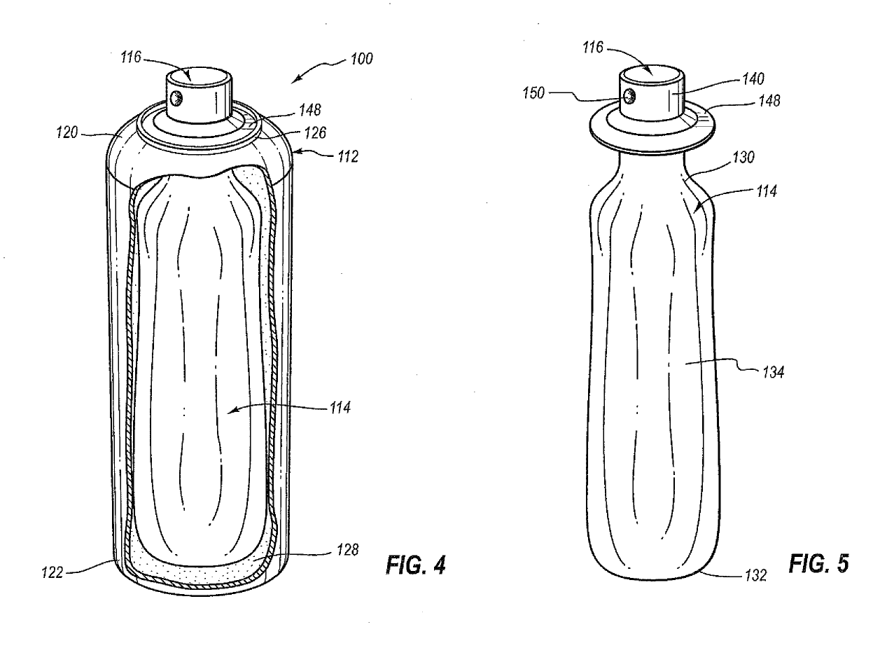

Referring now to FIGS. 4 and 5, another example scent dispensing system 100 is shown and described. Scent dispensing system 100 includes an outer container 112, an inner container 114, and a dispensing mechanism 116. The inner container 114 is constructed substantially as a bag type device. The inner container 114 and dispensing mechanism 116 may be preassembled as shown in FIG. 4 and mounted to the outer container 112 in a separate assembly step that includes securing a cap 148 of dispensing mechanism 116 to a lip 126 at a top end 120 of the outer container 112. The outer container 112 may include a generally flat surface at the bottom end 122 to promote the scent fluid dispensing system 100 standing on its end. The outer container 112 may have a generally cylindrical shape that is circular in cross section. The inner container 114 may have a generally elongate structure. At least one portion of the inner container 114 (i.e., a portion of at least one sidewall 134 that extends between first and second ends 130, 132) may have a generally flexible construction that permits at least some deformation of the inner container 114 as the volume of scent fluid retained within the inner container 114 is dispensed through the dispensing mechanism 116.

The outer container 112 defines an interior volume 128 within which a volume of pressurized fluid 62 is retained and the inner container 114 is positioned. Further, at least portions of the dispensing mechanism 116 may extend into and be positioned within the interior volume 128. The pressurized fluid retained in the outer container 112 may exert a pressure upon an outer surface of the inner container 114 to increase a pressure condition of the volume of scent fluid that is retained within the inner container 114. In at least some arrangements, the pressurized fluid may help maintain the volume of scent fluid under a substantially constant pressure during dispensing of the volume of scent fluid.

In at least some arrangements, the scent dispensing system 100 is constructed and arranged to provide a continuous rate of dispensing of the volume of scent fluid regardless of the pressure condition of the scent fluid within the inner container 114. For example, the pressure condition of the scent fluid may decrease as the size and/or shape of the inner container 114 decreases as the scent fluid is dispensed through the dispensing mechanism 116. This reduced size and/or shape of the inner container 114 may provide an increase of space within the interior volume 128 within which the pressurized fluid can expand (i.e., in a case of the pressurized fluid being a gas), thus reducing the pressure exerted by the pressurized fluid on the inner container 114. The dispensing mechanism 116 may include features such as an increase in the size of an outlet 150 that compensates for the reduced pressure of the scent fluid to help maintain a constant rate of dispensing of the scent fluid.

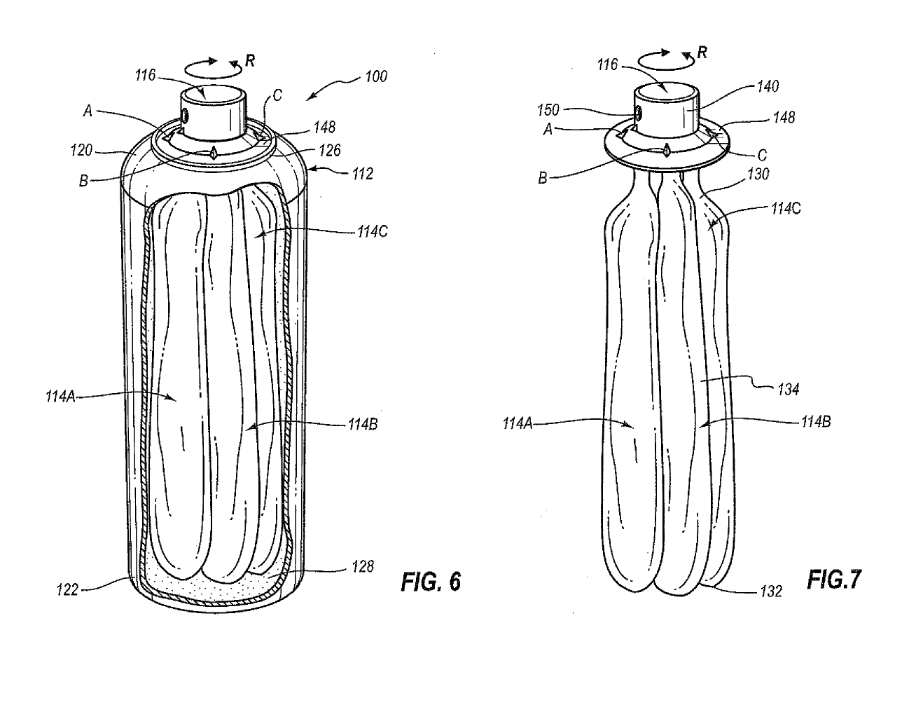

Other example scent dispensing systems may include alternative arrangements and constructions for the inner container and dispensing mechanism 116. In one example, as shown in FIGS. 6 and 7, multiple inner containers 114A-C are included within a single outer container. Each container 114A-C may include a volume of a single scent fluid or other type of fluid (e.g., bug repellant). Alternatively, a different scent fluid may be stored in and dispensed from each container 114A-C. The scent fluid held in each container 114A-C may be accessed by actuating a valve mechanism associated with the dispensing mechanism 116. The valve mechanism may be actuated, for example, by rotating the dispensing mechanism 116 in a direction (e.g., direction R) between positions A, B, C. Each actuated position A-C may correspond to an arrangement of the dispensing mechanism 116 that permits dispensing of the scent fluid held in a particular container 114A-C, respectively.

The containers 114A-C may have the same size and define a substantially similar volume for retaining a scent fluid. The containers 114A-C may be limited to two containers or may include four or more containers. In some arrangements, at least one of the plurality of containers 114A-C may have a different size or shape than the other containers. A size of the containers may correspond to the scent fluid that is most frequently dispensed by the user. In some arrangements, at least one of the containers 114A-C may be refillable or replaceable. In some examples, the volume of pressurized fluid retained between the outer container 112 and the containers 114A-C may be recharged to increase a pressure level of the pressurized fluid, such as when the volume of scent fluid in the containers 114A-C is depleted.

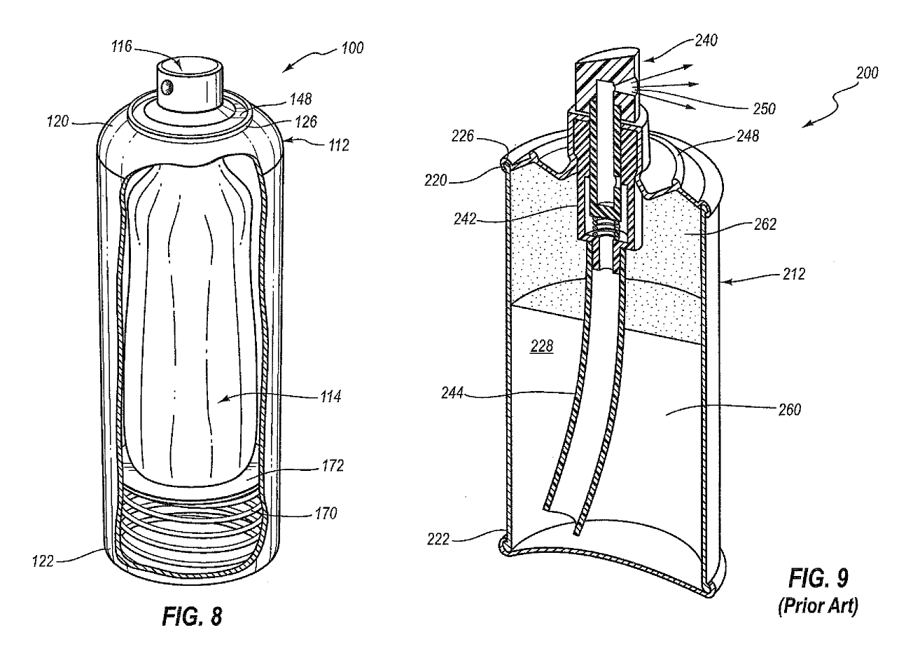

Other example scent dispensing systems may include alternative constructions for applying a pressure condition to an outer surface of the inner container 114. In one example, as shown in FIG. 8, at least one spring or biasing member 170 is included within the outer container 112. The biasing member may be arranged to apply a biasing force along the second end 132 (e.g., in a direction toward the first end 130 attends to compress the inner container 114 as the volume of scented fluid is dispensed). Specifically, the bias member 170 may be arranged to contact a plate 172 to apply a biasing force to an external surface of the interior container 114. This biasing member may be used in combination with or in place of the volume of pressurized fluid (i.e., pressurized fluid 62 discussed above). The biasing member may alternatively be arranged to apply a biasing force to the sidewalls of the inner container 114. In some arrangements, a plurality of biasing members may be used to apply a force to the inner container 114.

In contrast to the scent fluid dispensing systems 10, 100 described above, a prior art propellant-driven dispensing system 200 is shown with reference to FIG. 9, which includes a mixture of a pressurized fluid 262 and a volume of fluid 260. Dispensing system 200 includes an outer container 212, a dispensing mechanism 216, and the volume of scented fluid 260 and volume of pressurized fluid 262 both held in the outer container 212.

The outer container 212 includes top and bottom ends 220, 222, a lip 226 defined around the top end 220, and an interior volume 228. The dispensing mechanism 216 includes an actuator 240, a valve assembly 242, a dip tube 244, a cap 248, and an outlet 250.

The pressurized fluid 262 mixes with the scent fluid 260 within the interior volume 228. The mixture of scent fluids 268 and pressurized fluid 262 travel through the dip tube 244, through the valve assembly 242 and out of the outlet 250 upon actuation of the actuator 240. The scent dispensing system 200 suffers from the numerous shortcomings set forth above.

The preceding description has been presented only to illustrate and describe exemplary embodiments of the present disclosure. It is not intended to be exhaustive or to limit the invention to any precise form disclosed. Many modifications and variations are possible in light of the above teachings.

What is claimed is:

1. An apparatus for dispensing a scent fluid, the apparatus comprising:
a canister containing a volume of pressurized fluid;
a bag positioned in the canister and containing a volume of the scent fluid, the volume of scent fluid being physically separated from the pressurized fluid;
a dispensing mechanism in fluid communication with the volume of scent fluid, the dispensing mechanism being operable to dispense the volume of scent fluid.

2. The apparatus of claim 1, wherein the pressurized fluid exerts a compressive force on an exterior surface of the bag to increase a pressure condition of the volume of scent fluid.

3. The apparatus of claim 1, wherein the dispensing mechanism is operable to dispense the volume of scent fluid at a substantially constant rate.

4. The apparatus of claim 1, wherein the volume of pressurized fluid maintains the volume of scent fluid at a substantially constant pressure condition in the bag.

5. The apparatus of claim 1, wherein the bag includes at least one flexible sidewall.

6. The apparatus of claim 1, wherein the dispensing mechanism includes an ON state wherein the volume of scent fluid is dispensed and an OFF state wherein the volume of scent fluid is not dispensed, and a device that retains the dispensing mechanism in the ON state.

7. The apparatus of claim 1, wherein the pressurized fluid is a gas.

8. The apparatus of claim 1, wherein the scent fluid comprises a liquid composition that attracts an animal.

9. The apparatus of claim 1, wherein the scent fluid comprises a liquid composition that masks scent.

10. A method of dispensing a scent fluid for use in hunting, comprising:
providing a scent dispensing device that includes a first container of scent fluid positioned in a second container of pressurized fluid, and a dispensing mechanism in fluid communication with the scent fluid;
exerting pressure on an outer surface of the first container with the pressurized fluid to increase a pressure condition of the scent fluid;
activating the dispensing mechanism to dispense a volume of the scent fluid.

11. The method of claim 10, wherein dispensing a volume of the scent fluid includes dispensing the scent fluid at a substantially constant rate.

12. The method of claim 10, wherein dispensing a volume of the scent fluid includes dispensing the scent fluid continuously.

13. The method of claim 10, wherein activating the dispensing mechanism include locking the dispensing mechanism in an ON state to provide a continuous flow of the scent fluid.

14. The method of claim 10, wherein dispensing a volume of the scent fluid includes dispensing the scent fluid from the first and second containers.

15. A scent fluid delivery system, comprising:
a housing defining a housing interior;
a scent fluid container positioned in the housing interior, the scent fluid container having at least one flexible wall, the scent fluid container retaining a volume of scent fluid having a chemical composition;
a volume of pressurized fluid retained in the housing interior and configured to act upon an outer surface of the at least one flexible wall of the scent fluid container to increase a pressure condition of the scent fluid within the scent container;
a dispensing mechanism in fluid communication with the volume of scent fluid.

16. The scent fluid delivery system of claim 15, wherein the scent fluid container is configured as a bag structure.

17. The scent fluid delivery system of claim 15, wherein the dispensing mechanism is configured to dispense the volume of scent fluid at a constant rate.

18. The scent fluid delivery system of claim 15, wherein the volume of pressurized fluid is physically separated from the volume of scent fluid.

19. The scent fluid delivery system of claim 15, wherein the volume of pressurized fluid maintains the volume of scent fluid at a substantially constant pressure condition.

20. The scent fluid delivery system of claim 15, wherein the housing has a generally cylindrical shape having a rigid construction, and the dispensing mechanism is positioned at one end of the housing.
